(19) United States
(12) Patent Application Publication
(10) Pub. No.: US 2016/0374504 A1
(43) Pub. Date: Dec. 29, 2016

(54) CONTINUOUS PRODUCTION OF AN EXTRACT

(71) Applicant: Meltz, LLC, Ipswich, MA (US)

(72) Inventor: Douglas M. HOON, Guilford, CT (US)

(21) Appl. No.: 15/196,912

(22) Filed: Jun. 29, 2016

Related U.S. Application Data
(60) Provisional application No. 62/185,937, filed on Jun. 29, 2015.

(51) Int. Cl. A47J 31/42; A23F 5/24; A23F 5/26; A47J 31/44; A23F 5/04; A23F 5/08

(52) U.S. Cl. CPC A47J 31/42; A23F 5/04; A23F 5/08; A23F 5/26; A47J 31/4403; A23F 5/243

(57) ABSTRACT

Techniques and systems are provided for continuous production of a coffee extract product. A method includes roasting green coffee beans in a roaster, which may be a continuous roaster, and grinding the roasted beans in a grinder, which may be a continuous grinder. The ground roasted coffee beans are brewed in a continuous brewing station, where the ground roasted coffee beans and water co-flow through a tube during the brewing process. The tube has dimensions selected to provide a desired brewing time. The brewed coffee is separated into a liquid coffee extract and coffee grounds. The liquid coffee extract is cooled to a desired temperature, packaged, and frozen.

### INCORPORATION BY REFERENCE

This application claims benefit under 35 U.S.C. 119(e) to U.S. Provisional Patent Application No. 62/185,937, filed on Jun. 29, 2015, the entirety of which is explicitly incorporated by reference herein.

All patents, patent applications and publications cited herein are hereby incorporated by reference in their entirety. The disclosures of these publications in their entireties are hereby incorporated by reference into this application in order to more fully describe the state of the art as known to those skilled therein as of the date of the invention described herein.

### TECHNICAL FIELD

The technical field relates generally to a continuous process and system for production of a liquid coffee extract.

### BACKGROUND

The process of extraction of soluble solids from a granulated compound using a single- or multi-column process, wherein the granulated compound is captured and a solvent is passed through it, can be plagued with uncontrolled conditions. If the compound is ground coffee, these problems may include under-extraction (e.g., leading to loss of revenue), over-extraction (e.g., hydrolysis, leading to bitter taste and shelf unstable extracts), inadequate column length (e.g., inadequate Brix, leading to the need for concentrating post extraction), and/or a plugged column (e.g., loss of flow, revenue loss and excessive extraction times). A “column” is often a container—such as a tank or a large pipe—that can be filled with coffee grounds. The column can include inlets and outlets that allow a solvent such as water to be introduced and/or pumped through with the solvent being used to remove various soluble components from the grounds.

Many such extraction systems are often difficult to load, unload or clean. Others are unable to simply bypass areas of an extraction column that are either spent or plugged, often requiring the entire system to be taken off-line. These systems offer less than optimal control of every aspect of extraction, including control of contact time, temperature, pressure, dry spotting, and under- or over-extraction. Thus, conventional systems make it very difficult to control the quality of the final coffee product, often leading to less than optimal taste and aroma of the coffee. Further, it is very difficult to achieve product consistency batch to batch with conventional systems.

Another problem which often thwarts the goal of producing the best tasting coffee or tea is the opportunity for oxidation of critical flavor and aroma compounds to occur at every stage between the time the coffee bean is roasted and ground and the time the extract is produced and packaged.

For coffee applications where the very highest quality extract is desired and chemical oxidation of important flavor and aroma compounds is an unwanted quality issue, batch processes, in general, may not be ideal. A batch process is often the performing of an industrial process on material in batches of a limited quantity or number. For some industrial processes of coffee extraction today, batch sizes can be in the range of about 1000 to 10,000 pounds of ground roasted coffee, or more. In many instances, there is a start and a stop to a batch process, after which certain compounds or materials are changed or replenished, and the cycle is then repeated. In contrast, a continuous process is often one which has the capability to run indefinitely and whose compounds or materials are steadily replaced as they are used. As an example, if the goal is to roast, grind, brew (e.g., extract) and/or package a liquid extract with minimal delays between steps to optimize flavor (e.g., minimize oxidation of the product), any batch process, which requires queuing time between steps so the required quantity of product can be accumulated for the next step, may introduce unnecessary opportunities for quality loss (e.g., via oxidation). For example, if there is a wait between roasting and grinding, some portion of the desirable aromatic compounds created by the roasting process may be lost to the atmosphere. In some processes, the longer the wait period between various steps, often the more quality that is lost. Similarly, if there is a wait following grinding before the grounds are introduced to the brewing process, additional aromatic compounds may be lost and, what is potentially worse, if the right atmospheric conditions are not provided, there can be a very high rate of oxidation of the flavor and aroma compounds facilitated by the now (due to grinding) small particle sizes and corresponding larger surface areas available for these undesirable reactions.

### SUMMARY

Some embodiments disclosed herein relate to systems and processes for continuous production of coffee extract. Producing a coffee-extract is a multi-step process that involves multiple distinct steps which are typically performed in different processing areas (e.g., different vessels, devices, chambers, e.g., roasting system, grinding system, brewing system, filtering system, cooling system, etc.). In one or more embodiments, the coffee product proceeds from one area to the next processing area continuously and without delays or waiting periods (e.g., the coffee product proceeds directly from the continuous grinder to the continuous brewing station without the need to wait for a sufficient amount of product to accumulate, thereby improving coffee quality). In one or more embodiments, there is no queuing or otherwise waiting for a sufficient amount of product to accumulate before proceeding to a next step of the extraction process. In one or more embodiments, the period of time for the product to move from one step to the next is several seconds, e.g., under about 20, 30, 50, 60 seconds. In one or more embodiments, the period of time from the product to move from one step to the next is the time that it takes to transport the product from one device (e.g., roaster, e.g., continuous roaster or batch roaster) to the next device (e.g., continuous grinder). In one or more embodiments, running of the extraction process continuously and without delays results in a higher quality final product (e.g., coffee extract), for example because there are less opportunities for quality loss via oxidation. In one or more embodiments, the final product is of higher quality because the amount of time that the coffee product is exposed to oxygen is minimized. In some embodiments, the continuous process allows for precise control over Brix content of the liquid coffee extract. In some embodiments, the continuous process allows for precise control over the amount of extractables in the final product, e.g., so that the final product is not over-extracted, generally leading to poor (e.g., bitter) taste and not under-extracted, leading to product being wasted (and also leading to an undesirable taste profile).

In some embodiments, the continuous process allows for convenient cleaning and maintenance as the different devices involved in the continuous process may be taken off-line at any convenient time (with the only general exception that the roasting process should be completed if it has been started so that product is not wasted). The process to take the continuous system in accordance with some embodiments described herein off-line is much simpler, quicker, and results in less product loss and less product quality loss than with typical batch systems. For example, with typical batch systems, it is generally necessary for the batch processes that have already been started to be completed before a system may be taken off-line.

In one or more embodiments, the coffee is roasted in a non-oxidizing environment, an oxygen-deprived, or an oxygen-free environment (e.g., inert gas environment, e.g., Nitrogen gas, CO₂ gas). In one or more embodiments, the coffee is ground in a non-oxidizing environment, an oxygen-deprived, or an oxygen-free environment (e.g., inert gas environment, e.g., Nitrogen gas, CO₂ gas). In one or more embodiments, the coffee is roasted and ground in a non-oxidizing environment, an oxygen-deprived, or an oxygen-free environment (e.g., inert gas environment, e.g., Nitrogen gas, CO₂ gas). In one or more embodiments any of the steps (including all the steps) of the continuous extract production process may be carried out in a non-oxidizing environment, an oxygen-deprived, or an oxygen-free environment (e.g., inert gas environment, e.g., Nitrogen gas, CO₂ gas).

While the goal of any process is to yield a consistent output in terms of measurable parameters, e.g., BRIX value, percentage of extraction, or even taste, in reality there is always some level of variation over time. One way of addressing this type of variation is to allow, in some embodiments, some pooling of the final product and an opportunity to mix the output from one block of time with the output from one or more other blocks of time to create a blend that is more uniform or homogenous. Some embodiments disclosed herein relate to the production of a homogenized product (e.g., homogenized coffee extract product). Some embodiments disclosed herein relate to the production of a homogenized product with a pre-set Brix ratio. In some embodiments, a number of sensors are included throughout the system, e.g., pressure sensors, temperature sensors, to ensure a homogenized product.

In some embodiments, ground roasted coffee and water pass through one or more segments of a tube of a brewing station and then pass through a centrifuge and/or filter to obtain liquid coffee extract having a first quality characteristic. In some embodiments, the liquid coffee extract having the first quality characteristic has high quality. In some embodiments, the liquid coffee extract having the first quality characteristic has higher quality than any liquid coffee extract that may subsequently be obtained using the same coffee grinds (e.g., if the coffee grinds were re-run back through the brewing station). In some embodiments, the coffee grounds that were separated from the liquid coffee extract having the first quality characteristic are re-routed back to the continuous brewing station to pass through one or more segments of the tube of the brewing station (the one or more segments may be identical or different than the ones the ground roasted coffee passed through) and then through a centrifuge and/or filter to obtain additional liquid coffee extract having a second quality characteristic. In some embodiments, the liquid coffee extract having the first quality characteristic is of higher quality (e.g., than the liquid coffee extract having the second quality characteristic) may be used to obtain coffee having heightened quality standards, e.g., high quality espresso. In some embodiments, the liquid coffee extract having the second quality characteristic has different quality (e.g., lower quality) than the liquid coffee extract having the first quality characteristic. In some embodiments, the liquid coffee extract having the second quality characteristic may be used in products that have different (e.g., lower, less strict) quality standards, e.g., for coffee flavoring (e.g., for coffee-flavored ice cream products) or for lower quality coffee or instant coffee. In some embodiments, the liquid coffee extracts having the first and second quality characteristics may be combined together in predetermined proportions to obtain a liquid coffee extract having a third quality characteristic.

One aspect disclosed herein relates to a method for continuously producing a liquid coffee extract. The method includes the steps of (1) roasting green coffee beans in a roaster to form roasted coffee beans; (2) transporting the roasted coffee beans into a grinder; (3) grinding the roasted coffee beans in the grinder to form ground roasted coffee beans; (4) transporting the ground roasted coffee beans into a continuous brewing station; (5) brewing the ground roasted coffee beans in the continuous brewing station to form a liquid coffee extract and a spent coffee grounds mixture; (6) transporting the liquid coffee extract and spent coffee grounds mixture to a continuous separation system through an outlet port of the continuous brewing station; and (7) separating, using the continuous separation system, the liquid coffee extract from the spent coffee grounds. The brewing step includes continuously receiving over a first time duration a predetermined quantity of the ground roasted coffee beans at an inlet port of the continuous brewing station; continuously receiving over the first time duration a predetermined quantity of water at the inlet port of the continuous brewing station; and continuously co-flowing over the first time duration the predetermined quantity of ground roasted coffee beans and the predetermined quantity of water through a tube, the tube having dimensions selected to provide a predetermined brewing time.

In some embodiments, the method includes roasting the green coffee beans in a continuous roaster.

In some embodiments, the method includes grinding the roasted coffee beans in a continuous grinder.

In some embodiments, the method includes cooling the liquid coffee extract to a cooled extract temperature prior to step (7) or after step (7).

In some embodiments, the method includes packaging the cooled liquid coffee extract. In some embodiments, the method includes packaging the cooled liquid coffee extract into single-serve packaging. In some embodiments, the method includes packaging the cooled liquid coffee extract into bulk packaging (e.g., half-gallon, gallon, 5 gallon, 50 gallon, 100 gallon 500 gallon, etc. bags).

In some embodiments, the method includes packaging the liquid coffee extract and flash freezing packaged liquid extract to preserve freshness. In some embodiments, the method includes transporting the packaged liquid extract in a temperature-controlled container.

In some embodiments, the separating step comprises filtering the liquid coffee extract and the spent coffee grounds mixture to achieve a predetermined Brix value for the liquid coffee extract. In some embodiments, the separating step includes separating the liquid coffee extract from the spent coffee grounds in a spinning cone column. In some embodiments, the separating step includes centrifuging the liquid coffee extract and the spent coffee grounds mixture. In some embodiments, the separating step is a two-step process comprising filtering and centrifuging the liquid coffee extract and the spent coffee grounds mixture in a non-oxidizing environment. In some embodiments, the separating step is a two-step process that includes filtering and centrifuging the liquid coffee extract and the spent coffee grounds mixture. In some embodiments, the collection from the centrifuge is chilled to about 30° F. to 50° F. (about −1° C. to 10° C.).

In some embodiments, the method includes measuring a Brix value of the liquid coffee extract following the separation step.

In some embodiments, the roasted coffee beans are transported from the roaster (e.g., continuous roaster or batch roaster, e.g., fluidized bed roaster) to a storage container for a predetermined storage period prior to step (2). In some embodiments, the roasted beans are transported from the roaster (e.g., continuous roaster or batch roaster) to a bean chilling system. In some embodiments, the beans are chilled in a non-oxidizing environment.

In some embodiments, the method includes sorting the ground roasted coffee beans after grinding to achieve uniform coffee grind size prior to step (4).

In some embodiments, the method includes adjusting at least one of the predetermined quantity and temperature of the water to control a Brix value of the liquid coffee extract.

In some embodiments, the tube is selected from the group consisting of a coil, a straight tube, serpentine tube, a shell-and-tube. In some embodiments, the tube is dimpled to impart turbulence. In some embodiments, the tube is selected to control an amount of agitation to prevent addition of undesirable solids to the liquid coffee extract. In some embodiments, the dimensions of the tube are selected to provide the predetermined brewing time and to provide predetermined pressure and temperature conditions within the tube.

In some embodiments, the tube has multiple segments, the method comprising selecting which one or more of the multiple segments of the tube receives at least a portion of the predetermined quantity of ground roasted coffee beans and at least a portion of the predetermined quantity of water and which one or more of the multiple segments of the tube does not receive ground roasted coffee beans and water to provide for the liquid coffee extract having predetermined characteristics. In some embodiments, only certain tube segments are used during operation. In some embodiments, one or more of the multiple segments may be off-line.

In some embodiments, the tube has multiple segments, and the method includes replacing or modifying one or more segments of the tube to modify a rate of extraction of compounds from the ground roasted coffee beans. In some embodiments, one or more segments of the tube may be replaced with a different segment to achieve desired characteristics of the liquid coffee extract.

In some embodiments, the tube has multiple segments, at least one of the multiple segments including at least one pressure transducer, and the method includes measuring an internal tube pressure and adjusting the internal tube pressure to obtain the liquid coffee extract having predetermined quality characteristics. In some embodiments, the pressure is pulsed to enhance extraction of dissolvable solids.

In some embodiments, the tube has multiple segments, and the method includes independently controlling operating conditions for each of the multiple segments.

In some embodiments, the tube has multiple segments, wherein at least some of the multiple segments are arranged in series, wherein the brewing step includes flowing the ground roasted coffee beans and the water through more than one segment in the series to achieve an additional level of liquid coffee extraction relative to flow through a single tube segment.

In some embodiments, the tube has multiple segments, wherein at least some of the multiple segments are arranged in parallel, wherein the brewing step includes flowing the ground roasted coffee beans and the water through more than one segment of the tube in parallel to increase output relative to flow through a single tube segment.

In some embodiments, the tube includes multiple segments, the multiple segments including a first group of tube segments and a second group of tube segments, wherein the ground roasted coffee beans flow through the first group of tube segments in step (5), and the method further includes, after step (7), transporting the separated spent coffee grounds to the second group of tube segments, distinct from the first group of tube segments, for further extraction.

In some embodiments, the inlet pump is a twin-screw pump or a positive displacement pump.

In some embodiments, at least one or more of the steps (1)-(4) is completed in a non-oxidizing environment or a reduced-oxygen environment. In some embodiments, all the steps (1)-(4) are completed in a non-oxidizing environment or a reduced-oxygen environment.

In some embodiments, at least one or more of the steps of obtaining a liquid extract (1)-(7) is completed in a non-oxidizing environment or a reduced-oxygen environment. In some embodiments, all the steps of obtaining a liquid extract (1)-(7) are completed in a non-oxidizing environment or a reduced-oxygen environment. In some embodiments, one or more of the roasting, grinding, separating and packaging processes are performed in a non-oxidizing environment.

A further aspect disclosed herein relates to a system for continuously producing a liquid coffee extract. The system includes (1) a roaster for roasting green coffee beans to form roasted coffee beans; (2) a grinder for grinding the roasted coffee beans to form ground roasted coffee beans; (3) a continuous brewing station for forming a liquid coffee extract and a spent coffee grounds mixture; and (4) a continuous separation system for separating the liquid coffee extract from the spent coffee grounds. The continuous brewing station includes an inlet port for continuously receiving over a first duration a predetermined quantity of the ground roasted coffee beans and a predetermined quantity of water; a tube in fluid communication with the inlet port comprising multiple segments, wherein at least one segment has dimensions selected to provide a predetermined brewing time; and an inlet pump for co-flowing the predetermined quantity of ground roasted coffee beans and the predetermined quantity of water into the tube.

In some embodiments, the output of the continuous brewing system is cooled using a heat exchanger. In some embodiments, the liquid coffee extract is cooled using a heat exchanger after going through the separation system. In some embodiments, the coffee is roasted and ground in a non-oxidizing environment or a reduced-oxygen environment. In some embodiments, the coffee is brewed in a non-oxidizing environment. In some embodiments, the separating takes place in a non-oxidizing environment. In some embodiments, one or more of the roasting, grinding, separating and packaging processes are performed in a non-oxidizing environment.

Elements of embodiments described with respect to a given aspect of the invention may be used in various embodiments of another aspect of the invention. For example, it is contemplated that features of dependent claims depending from one independent claim can be used in an apparatus and/or methods of any of the other independent claims.

### BRIEF DESCRIPTION OF THE FIGURES

Various objects, features, and advantages of the disclosed subject matter can be more fully appreciated with reference to the following detailed description of the disclosed subject matter when considered in connection with the following drawings, in which like reference numerals identify like elements. The figures are presented for the purpose of illustration only and are not intended to be limiting.

FIG. 1 illustrates the portions of a continuous process from roasting through brewing of the grounds to create a liquid extract, according to some embodiments.

FIG. 2 illustrates other subsequent portions of a continuous process from separating the grounds from the liquid extract to packaging and transport of the product, according to some embodiments.

FIG. 3A is a flowchart outlining various steps of a continuous process for creation of liquid coffee extract, packaging, flash freezing, and transport of the product, according to some embodiments.

FIG. 3B is a flowchart outlining various steps of a continuous process for creation of liquid coffee extract, packaging, flash freezing, and transport of the product, according to some embodiments.

FIG. 4 illustrates two types of pumps for moving the slurry through the tubing during the brewing process, according to some embodiments.

### DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the examples provided below are exemplary, and that it is contemplated that there are other systems and methods that are within the scope of the disclosed subject matter.

For ease of understanding and general clarity, the techniques described herein will be described in the exemplary context of creating a coffee extract. It is understood, however, that these same techniques could apply to other products such as tea where obtaining extractable solids from a compound using a specific solvent is of interest.

In some embodiments, the techniques described herein generally relate to the continuous industrial processing of coffee, not the brewing of coffee in the home or in a coffee shop where individual cups or pots of coffee are prepared. More particularly, the techniques described herein, taken as a whole, relate to a continuous, integrated process of extraction for coffee or tea production and packaging the product. In some embodiments, the product is packaged into a portion-controlled (e.g., individually packaged) product. In some embodiments, the product is packaged into bulk packaging (e.g., large bags of product, e.g., about 5, 10, 100, 500 gallon packages). It will be understood that many of these same techniques can equally apply to other sensitive/easily oxidized food products that are best processed quickly and then packaged for preservation of optimum freshness. It will also be understood that one or more steps in the described continuous process could be replaced with a functionally equivalent batch process. In some examples, while this change in the configuration to replace one or more steps with a functionally equivalent batch process may change the overall quality of the product by allowing more time for oxidation, the remainder of the continuous system should continue to operate at the same efficiency and quality as the original fully continuous system. For example, if a batch roaster were substituted for a continuous roaster, some negative effects might be experienced due to quality losses between roasting and grinding, but the remainder of the system would function generally as before, and a majority of the benefits of continuous roasting may still be enjoyed by the system.

For certain roast types, e.g., dark roasts, it may be desirable to allow for a storage period after roasting and prior to grinding (e.g., to reduce dust formation during the grinding process). The roasted beans may be transported to a storage container for a suitable time period (e.g., 12 hours, 24 hours, or 12-24 hours depending on the desired extract profile). The techniques described herein allow for halting the extraction process at a suitable time. In some embodiments, the extraction process should be terminated once any beans that are in the roaster have finished roasting to prevent wasting any product. In some embodiments, it may be desirable to allow for a chilling period after roasting and prior to grinding. In some embodiments, the roasted beans may be transported to a chilling area for a suitable time period. In some embodiments, the roasted coffee beans may be chilled immediately after roasting. In some embodiments, after roasting, the coffee beans are chilled and/or stored in a non-oxidizing (e.g., inert gas) environment.

It will also be understood that while the process discussed herein may be run continuously, for some implementations, there may be a need or a desire to stop the process at certain time points. The techniques described herein provide a level of flexibility that has not been achieved with previously known techniques. It will be understood by those skilled in the art that the techniques discussed herein allow for running the extraction process continuously but also provide the flexibility to stop the process whenever needed. Generally, it is preferable to complete the roasting process before halting operation (e.g., so that the beans do not have to be discarded). In some implementations, the coffee extraction facility may be run on a two-shift schedule (or e.g., other non-24 hour shift schedule), and it is possible to stop the continuous operation at a desired time (e.g., immediately prior to the end of the last shift). The system may then be purged as needed prior to re-starting the operation. In some embodiments, the system is purged or cleaned if a switch between different types of roasts (e.g., dark roast to light roast or vice versa) is desired. In some embodiments, purging or cleaning between different roast times is not required (e.g., the processing conditions are selected such that one type of roast may immediately follow another type of roast). In some embodiments, a pig may be run through the system between different types of roasts or different types of desired liquid coffee extracts (e.g., different Brix, different extractables). In some embodiments, a pig may be run through the system after the roasting or after the grinding step is completed. In some embodiments, a different type of product (e.g., different type of roast) may be run in a transition period (e.g., a third type of roast may be run between a first kind of roast and a second kind of roast). In some embodiments, different segments of the tube (e.g., tube 122) may provide different Brix or different extractables. In some embodiments, complete shutdown and clean-out of the system is performed between different types of products, e.g., based on product characteristics.

The techniques described herein provide a truly continuous process of coffee roasting, grinding, extraction and packaging for the premium coffee market. In some exemplary embodiments, green coffee beans are introduced into a continuous roaster, heated for a fixed and consistent period of time, whereupon they are discharged in the same continuous manner into a grinding machine. In some embodiments, the output of the grinding machine can be output directly into a continuous brewing stage, the output of the brewing device can immediately go into a continuous chiller, then into individual or small group serving size packaging with an inert or low reactivity gas (e.g., nitrogen or argon) used to fill any headspace, and finally, for the best preservation, the packaged product can be rapidly frozen and kept cold until used by the final consumer. In some embodiments, the techniques can be configured to optimize roasting conditions, achieve a very uniform particle size during grinding, and ensure the brewing process does not lead to over- or under-extraction. In some embodiments, the level of extractables in the final product may be controlled by controlling the solids/liquid residence time and the intensity of contact during the brewing process. In some embodiments, the water temperature, water purity, and/or oxygen content is precisely controlled. In some embodiments, the near-zero wait times between stages and/or the use of inert gases to shield the product from oxidation at one or more stages of production can ensure the lowest possible losses of desirable aromatic compounds and very little oxidation. Packaging and freezing can be used to protect this state of freshness and the consumer should thereby experience one of the best tasting cups of coffee possible. For example, the techniques set forth herein can be used to supply frozen contents for portion-controlled receptacles as described in U.S. Pat. No. 9,346,611, issued on May 24, 2016, entitled “Apparatus and Processes for Creating a Consumable Liquid Food or Beverage Product from Frozen Contents”, incorporated by reference herein.

In some embodiments, the roasting takes place in an oxygen-deprived or an oxygen-free environment, or in a oxygen-free environment (e.g., inert gas environment, e.g., nitrogen gas or CO₂ gas). In some embodiments, the grinding takes place in an oxygen-deprived or an oxygen-free environment (e.g., inert gas environment, e.g., nitrogen gas or CO₂ gas).

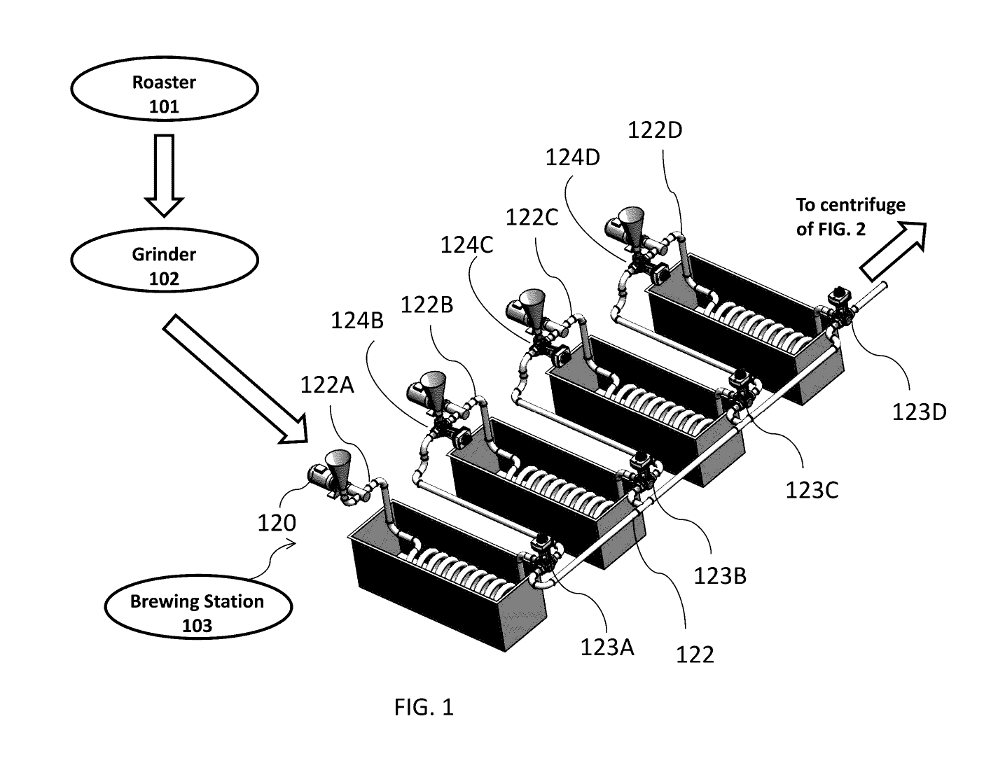

Referring to FIG. 1, a roaster 101 (e.g., continuous roaster) is based, for example, on a rotating drum principle (e.g., Neuhaus Neotec roaster). Such products are capable of roasting coffee at scales up to thousands or tens of thousands of coffee pounds per hour, with an individual bean passing through the system in a period of 3-15 minutes. In some embodiments, the roaster 101 is a rotating screw (auger) continuous roaster. In some embodiments, the rotating screw (auger) continuous roaster has various heat zones. The roaster 101 can provide excellent and precise controls over temperature and time for roasting and then quickly and efficiently cool the beans to minimize unwanted effects. In some embodiments, not shown in the figures, is the capture and condensation of volatile aromatics that can be added back into the extract later in the process, e.g., added back into the extract either just before or just after the cooling cycle. In some embodiments, the rate of bean roasting in the continuous roaster 101 is coordinated/timed with the remainder of the process so that roasted and cooled beans go to the grinding process with a delay of only about a few seconds, or because of transport distances to a grinder, a delay of about 2-3 minutes so any loss of freshness is minimized.

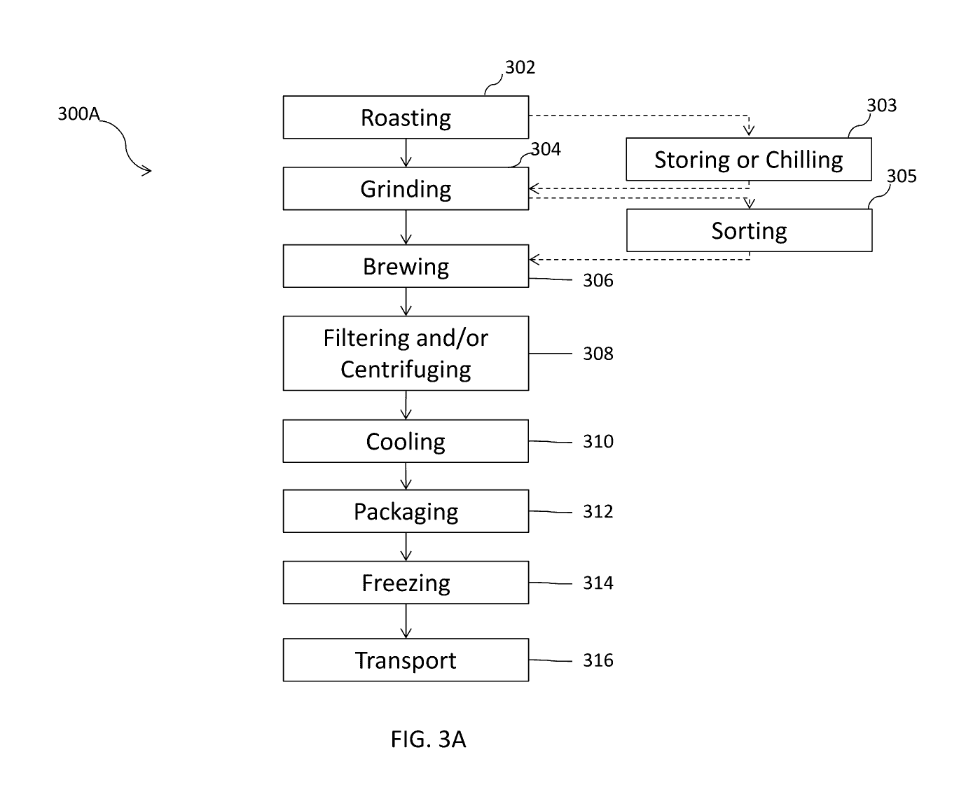

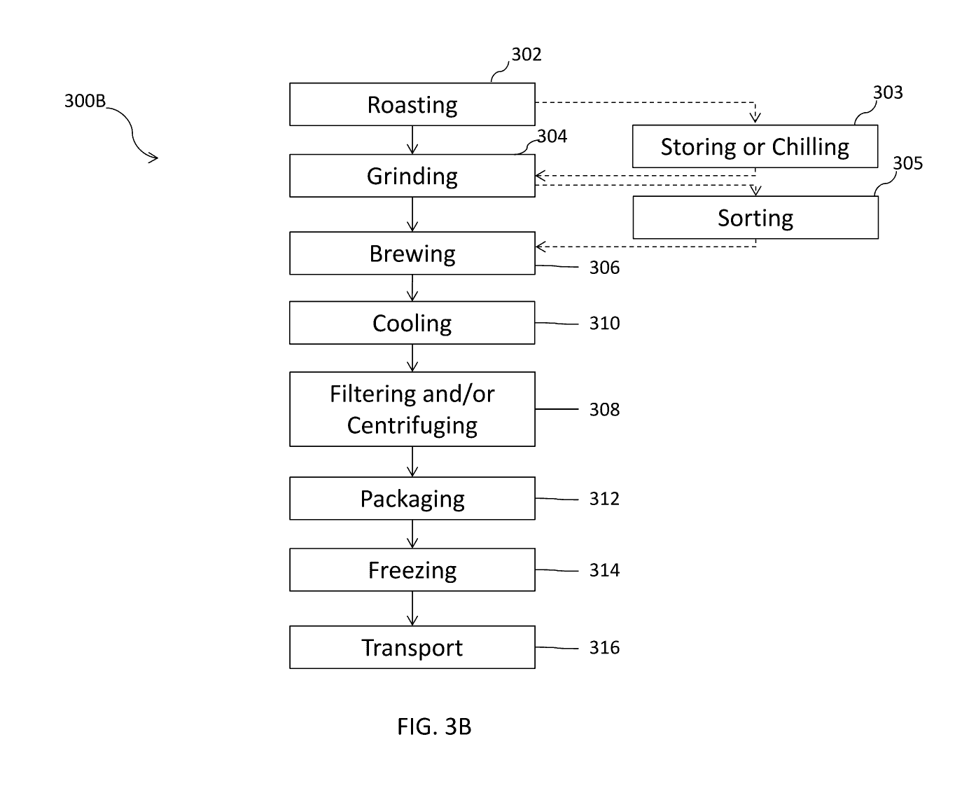

In some embodiments, the roaster 101 is a batch roaster, e.g., a fluidized bed roaster. In some embodiments (e.g., for certain types of roasts, e.g., for dark roasts), it may be desirable to allow the roasted beans to “breathe” for some period of time to modify the taste profile to a more desirable condition and/or to allow the beans to regain some firmness before grinding as a technique to minimize unwanted fracturing of the beans during grinding and the creation of large amounts of dust. In such embodiments, a first in/first out storage system (not shown) capable of holding the required volume of roasted beans and providing needed air or inert gas ventilation can be employed at the output of the continuous roaster 101 and before the next step to minimize oxidation and to maintain a consistent set of process conditions for each bean passing through the system (e.g., some beans do not see long queue times while other beans see much longer queue times, and some beans see no queue times at all). In some embodiments, the roasted coffee beans are transported from a continuous roaster 101 to a storage unit (e.g., as shown in step 303 of FIG. 3). In one or more embodiments, the roasted coffee beans are stored in an oxygen-deprived or an oxygen-free environment (e.g., inert gas environment, e.g., nitrogen gas environment. In some embodiments, the storage unit may be ventilated with air (e.g., ambient air) and/or inert gas. In other embodiments for certain dark roasts and/or for all roasted beans, the beans pass through an intermediate cooling station (not shown) wherein the bean temperature is reduced in temperature to enhance the efficiency, flavor retention and uniformity of grinder output as an alternative to allowing the beans to breathe for some period of time. The cooling temperature could be anything from cryogenic (e.g., liquid nitrogen temperatures of about −320° F. (about −196° C.) to about 32° F. (about 0° C.), but in certain implementations is in the range of about 0-32° F. (about −18 to about 0° C.). In some embodiments, the cooling may be carried out using a water mist quench.

Embodiments of the continuous process include a grinder 102 for grinding the coffee beans (e.g., a continuous grinder, e.g., a commercial grinder, e.g., Urschel Labs COMITROL® Unit). These devices are commercially available in a wide range of sizes and designs, capable of grinding or granulating beans at the rate of hundreds or thousands of pounds an hour. They are easily configured within a factory in pairs or larger groups to handle whatever output is needed. In some embodiments, the primary objective of this step is to create as uniform a particle size as possible. The equipment can be sized to have the capacity to grind the beans at whatever maximum brewing rate is needed at the next step, which could be hundreds or thousands of pounds per hour as noted above. In some embodiments, the output of the grinder 102 can be transported (e.g., by gravity or mechanically, e.g., by a conveyor belt or other transporting mechanism) directly to the inlet to the brewing process so the time delay between steps, time available for oxidation of the grounds, is measured in seconds (e.g., several seconds, e.g., 5-60 seconds) instead of hours. There may be an intermediate step of particle screening/sorting (e.g., optional step 305 shown in FIG. 3A or 3B, discussed in more detail below) after the grinding step (e.g., step 304 in FIG. 3A or 3B) to remove particles, both too large and too small, from the desired size range. Depending on the extraction process desired and the physical characteristics of the solvent (e.g., water) such as temperature and pressure, the ground particle size could range from about 0.1 mm diameter to about 2 mm diameter (e.g., about 0.1-0.25, 0.1-0.5, 0.25-0.75, 0.5-0.75, 0.5-1, 0.75-1.25, 1-1.25, 1-1.5, 1.25-1.75, 1.25-1.75, 1.5-2, 1.75-2 mm). Such a technique regarding narrow particle size distribution can be used in some embodiments to ensure individual particles/grounds are neither over-extracted (e.g., if the particle is too small) or under-extracted (e.g., if it is too large). In addition, in some embodiments, the sorting step aids in achieving a more homogeneous product with a superior taste profile.

There are multiple techniques that can be used to improve (e.g., narrow) the particle size distribution. In some embodiments, a milling process can be used to cleanly shave a small part of the bean from the whole and then immediately move that small particle out of the work zone so it is not processed further. This technique can avoid creation of excess “dust” which is generally undesirable. For example, different milling heads can be installed to allow production of particles ranging from fairly course (e.g., about 1-2 mm) to fine powders (e.g., about 0.1-0.3 mm). In some embodiments, a small amount of cold water (e.g., an amount of water about 10-20% less than the actual weight of the beans passing through the grinder) can be added to the beans during grinding or granulating to help capture more of the aromatic compounds released from the beans when milled—part of the pleasant aroma that may be detected during grinding that is not necessarily present when the coffee is consumed. The general nature of this machine also lends itself to little or no delay between grinding and brewing. The dry or wetted grounds can, for example, be gravity fed, or be assisted by a small auger, into the inlet of the brewing station, 103 in FIG. 1. A control that can be used at this grinding step is the weight of beans introduced into the mill per minute. The particle size may be controlled by selecting the appropriate milling head or granulating rollers and the speed of operation. In some embodiments, the particle size is controlled by passing a thin sheet or layer of coffee beans (e.g., such that the layer has a thickness equal to that of the thickness of one coffee bean) through the roller mill. In some embodiments, the particle size is controlled by preventing re-grinding of beans that have already been ground. In some embodiments, the coffee grounds pass through multiple rollers. In some embodiments, the particle size is controlled by passing the beans through a GRAN-U-LIZER™ available from Modern Process Equipment.

As illustrated in FIG. 1, coffee grounds from the grinder 102 and a measured amount of water calculated as a percentage of the weight of the dry grounds such that in total, the amount of water that has been added is appropriate for the desired BRIX) is introduced into the inlet port on pump 120 and then pushed through the pump into tube 122 where the water and coffee grounds remain in contact for the desired extraction time (e.g., about 1 to 5 minutes). In some embodiments, the amount of water that is added at the brewing stage is adjusted based on the desired requirement of wetting all the grinds. The water inlet is not shown in FIG. 1. In some embodiments, the grounds from the grinder 102 enter the pump inlet on one end only of the brewing station 103, e.g., the left-most pump 120 shown in FIG. 1. In some embodiments, e.g., if it is found that the full length of the tube (e.g., tube 122) is not needed to achieve the desired Brix concentration of solids, grounds can also be introduced to one or more of the other pumps at the same time (e.g., in parallel) to thereby maximize the productivity of the brewing station 103. In some embodiments, different kinds of segments of the tube, e.g., segments 122A, 122B, 122C, 122D, etc. may be used in the brewing station 103. In some embodiment, the segments (e.g., 122A, 122B, 122C, and 122D) of the tube 122 are different (e.g., segment 122A may have different characteristics than tubes 122B, 122C, and 122D). In some embodiments, some of the tube segments of the tube 122 are the same.

In some embodiments, the tube 122 can be any suitable conduit that allows close contact of water and ground coffee. In some embodiments, the tube 122 includes at least one segment that is a coil, a straight tube, or a serpentine tube. In some embodiments, the tube 122 includes at least one segment that is a shell-and-tube. In some embodiments, the tube 122 includes at least one segment that is dimpled (e.g., to impart turbulence on the flow and to reduce static mixing). In some embodiments, the tube 122 and the tube segments are selected to prevent excess agitation (e.g., to prevent the addition of solids to the extract). In some embodiments, at least one segment of the tube 122 can contain a static mixing element to enhance agitation and shear within the moving slurry.

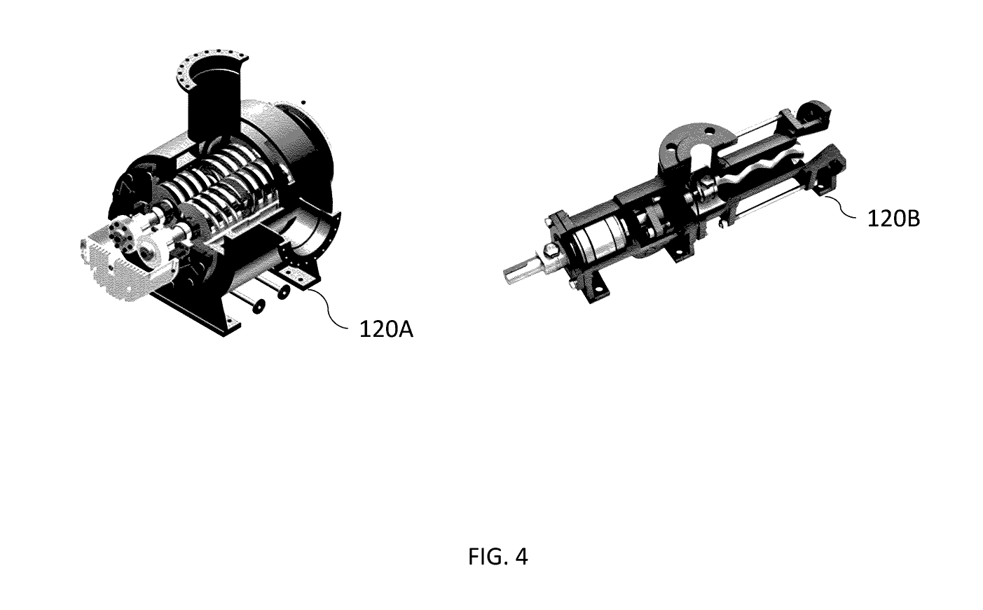

In some embodiments, pump 120 used for the continuous brewing operation is a positive displacement pump that is able to handle particle sizes up to about 2 or more mm in diameter, easily cleaned in place, can be “throttled” through a wide range of flow rates (e.g., from about 10% to about 100% of its rated capacity) and can develop high pressures (e.g., about 50-200 psi or more) even with low flows (e.g., about 10-30% of rated output). A twin screw pump, such as the one shown as 120A in FIG. 4 and as is well-known in the art, can be used in some embodiments. From a long-term maintenance and reliability perspective, since the twin screws never touch each other or the side walls of the pump, wear for these kinds of pumps is negligible. These pumps (e.g., twin screw pumps) introduce almost zero shear or air entrainment into the material being pumped and can tolerate high temperatures (e.g., well above the typical operating temperatures needed for coffee extraction—around about 195-205° F. (about 91-96° C.)). In some embodiments, a progressive cavity pump, which is often also known as a single screw pump as, for example, 120B of FIG. 4, can be used. Progressive cavity pumps are often widely used in food and beverage production, as well as pharmaceutical production. Progressive cavity pumps are very reliable, can be cleaned in place, throttled down without significant loss of pressure, and also have similar benefits with regard to low shear and air entrainment as twins screw pumps.

The water added to the coffee grounds can be, for example, ambient temperature water (e.g., about 70° F. (about 21° C.)) or water already heated to a preferred temperature, e.g., about 190-205° F. (about 88-96° C.), or water having any other temperature between ambient and heated (e.g., between about 70° F. (about 21° C.) to about 190-205° F. (about 88-96° C.)). The brewing techniques can include process controls on the motor drive, a component to measure flow rate, and/or the like. In some embodiments, the added water is filtered, de-oxygenated, and enhanced.

In one or more embodiments, the brewing station 103 also includes a tube 122 that includes at least one tube segment (e.g., 122A, 122B, 122C, 122D) where the actual brewing takes place. The output from the pump, the coffee and water slurry, goes into an electropolished stainless steel tube 122. The tube 122 includes one or more segments, e.g., coil(s) which may be used to save space, which is/are sized to give the coffee grounds and water the right dwell time and expose them to the optimum temperature and pressure for the production rate desired (and controlled by the pump) and level of extraction. As noted above, in some embodiments, the dwell time may range from approximately 1 minute to 5 minutes; optimum temperature may be in the range of about 190-205° F. (about 88-96° C.), and pressure may range from about 0 to about 200 psi, including pulsations in pressure to drive fluid into the grounds and then allow it to move back out. The tube where the brewing takes place may sit in a water bath that is continually heated to the same set point temperature as desired inside the tube (e.g., about 190-205° F. (about 88-96° C.)) and agitated (e.g., with local movement of at least about 0.5-5 inches per second (about 0.01-0.13 meters per second)) to increase the heat transfer rate into the slurry and improve overall temperature uniformity.

According to an exemplary embodiment, a tube (e.g., tube 122) is a coil including or consisting of four segments (e.g., 122A, 122B, 122C, 122D), each about 12 inches (about 0.3 m) in diameter made from 2.0 inch (about 0.05 m) OD tubing and the coil encompassing 10 revolutions in its spiral shape should provide a residence time of about 5 minutes for a production rate of approximately 15000 servings per hour for an extract which will produce an 8 ounce cup of coffee when diluted with the appropriate amount of water. In some embodiments, with a 4.0 inch (about 0.1 m) pitch to the coil, each tank can be about 4-5 feet (about 1.2-1.5 m) long. Each tank and coil combination may, at the operator's discretion, be heated or cooled to a different temperature than the other tanks. In some embodiments, a larger diameter tube (e.g., larger than about 2 inches (about 0.05 m)) may allow for a shorter tank with the same overall output and residence time, but, in some embodiments, the larger diameter of this tubing may also degrade the heat transfer characteristics and temperature uniformity for the slurry inside the tubing.

In some embodiments, each individual coil (e.g., tube 122) is removable and replaceable with different coils of similar or the same overall length, but with a larger pitch and fewer revolutions to be able to accommodate slower feed rates, if warranted, without negative impact on the extraction rate, e.g., to prevent over-extraction. For example, instead of a pitch of 4 inches (0.1 m) and 10 revolutions, in some embodiments, the coil might have only 5 revolutions and a pitch of 8 inches (0.2 m) for the same overall length. In some embodiments, the coils could also be assembled from a number of sub-sections (e.g., two or more sub-sections) that would provide greater flexibility on rate or extraction time. In some embodiments, sanitary connections, e.g., Tri-Clamp fittings, on each end of these coil sections should make swapping coils relatively easy and fast, which provides additional flexibility. In some embodiments, the techniques described herein can include process controls for the water temperature in the tank (e.g., a water temperature sensor may be provided), in-process measurement of the coffee slurry temperature (e.g., coffee slurry temperature sensors can be included at one or more locations), in-process measurement of the Brix, and/or the like. While the various temperature and Brix sensors are not specifically shown in FIG. 1, one skilled in the art would appreciate that such sensors may be added to a system of tubing as shown in the brewing station 103 of FIG. 1. While the temperature sensors could be located almost anywhere along the length of the tube 122, in some embodiments, the Brix sensors would preferably be placed at the end of a tube segment. In some embodiments, the brewing station 103 includes a tube (e.g., tube 122) with multiple segments, e.g., 2 or more segments, 3 or more segments, 4 or more segments, 5 or more segments, etc. One skilled in the art would also appreciate that jacketed tubing could also be used in lieu of the heated tank for helping to maintain internal slurry temperatures.

In some embodiments, several (e.g., more than two) temperature sensors could be provided along the length of a particular tube segment (e.g., along the length of a particular coil) to provide a temperature gradient throughout the tube segment. In some embodiments, a temperature sensor could be provided in the middle of a particular tube segment (e.g., in the middle of the coiled section of a tube segment). In some embodiments, a temperature sensor could be provided at an inlet and/or the outlet of a particular tube segment. Those of ordinary skill in the art could readily optimize the location or locations for placement of temperature sensors based on particular needs or operating characteristics.

In some embodiments, sensors are included to measure the water bath temperature. In some embodiments, agitation is provided to prevent hot spots in the tube or tube segment. In some embodiments, the temperature inside the tube or tube segment is controlled by measuring and controlling the temperature of the water bath. In some embodiments, temperature sensors could be located at one or more locations throughout the water bath.

In some embodiments, at least one pressure transducer is used for measuring internal tube pressure with one of them controlling a pressure regulating valve, such as valve 123A, at the end of a tube segment. In some embodiments, one or more pressure regulating valves is/are included along the length of sections of the tube 122 to detect possible plugs or otherwise monitor the operation of the brewing station 103. In some embodiments, each of the segments of the tube of the brewing station 103 includes at least one pressure transducer. In some embodiments, two or more pressure transducers are included. When the process is to be stopped at the end of a shift or at some other scheduled or unscheduled time, in some embodiments, it may be desirable to clean out the tube (or each particular segment thereof) and recover most of the slurry and formed extract. In some embodiments, a “pig” (e.g., some type of solid plug that can be pushed through the piping using inert gas pressure on the upstream side) can be used and air or nitrogen pressure applied behind it to push all of the contents into a centrifuge or another filtration or separation system. In some embodiments, the tubing can be purged only with air and/or nitrogen. Or, in some embodiments, the tubing can be disassembled, emptied manually or with help from a pig or air or nitrogen gas, to further facilitate recovery of the slurry and enable special cleaning.

In some embodiments, the brewing station 103 of the continuous extraction system may consist of a number of positive displacement pumps (e.g., 2 or more, 3 or more, 4 or more) organized serially, one after the other, to provide more positive control over the flow of the slurry through the brewing station. In FIG. 1, four separate tank and coil subsystems are shown as part of 103. Any one of those tank and coil subsystems can be considered the “brewing station” or two or more of them, or more than four, can alternatively be considered the “brewing section” for this description.

In some embodiments, the brewing station 103 configuration provides a high degree of flexibility to the extraction operation. It can be easily expanded to increase volume of production (e.g., by adding more tube segments). Each individual segment of the brewing station 103 can be operated under different, locally optimum conditions and with automated controls and the appropriate sensors (e.g., temperature sensors, pressure sensors, BRIX sensors) can be configured to run with very little operator oversight. In some embodiments, the system can be designed such that all of the components are inexpensive in comparison with systems configured from large pressure vessels and each of the components can be easily replaced to simplify maintenance.

One of ordinary skill in the art will appreciate that the operation of this brewing station 103, e.g., with the coffee grounds and the water traveling through the system together as a slurry, in the same direction, with the grounds continuously surrounded by the water, is different from the operation of counterflow systems or systems where the grounds are trapped within a defined volume and the water passes through them. Such flow is called “co-flow”, “co-current flow”, and “concurrent flow” herein. While the speed of extraction of soluble solids from the coffee may be slower using this configuration of brewing station than can typically be achieved with a counterflow system (as predicted by the lower solute concentration difference defined by Fick's Law), the maximum Brix concentration achievable (e.g., with more time) can be similar. Further, higher quality coffee product may be achieved using the systems as described in some embodiments herein that may not be achieved using counterflow systems. Moreover, the continuous method of operation, its capabilities for selectively varying the processing conditions with good control, and the simplicity of the system, and/or its lower capital and maintenance costs as compared to large batch systems or systems utilizing large pressure vessels, can be useful for long-term operations. Further, in some embodiments system outflows can be coordinated with downstream functions such as extract separation, chilling and/or packaging in a process with very little (or no) queuing times, so product quality remains high.

In some embodiments additional re-runs are required with the system as described herein to achieve the same Brix concentration as with a counterflow system. In some embodiments, ground roasted coffee and water pass through a first group of one or more segments of a tube of a brewing station and then pass through a centrifuge and/or filter to obtain liquid coffee extract having a first quality characteristic (e.g., suitable quality for high quality/grade espresso; e.g., sweet taste characteristic of high quality/grade espresso, complex acidity; lack of bitterness, etc.). In some embodiments, the liquid coffee extract having the first quality characteristic has high quality that may not generally be obtained with a counterflow system. In some embodiments, the liquid coffee extract having the first quality characteristic has higher quality than any liquid coffee extract that may subsequently be obtained using the same coffee grinds (e.g., if the coffee grinds were re-run back through one or more additional tube segments of the brewing station). In some embodiments, the coffee grounds that were separated from the liquid coffee extract having the first quality characteristic are re-routed back to the continuous brewing station to pass through one or more segments of the tube of the brewing station (the one or more segments may be identical or different than first group of tube segments) and then through a centrifuge and/or filter to obtain additional liquid coffee extract having a second quality characteristic. In some embodiments, the liquid coffee extract having the first quality characteristic is of higher quality (e.g., than the liquid coffee extract having the second quality characteristic) may be used to obtain coffee having heightened quality standards, e.g., high quality espresso. In some embodiments, the liquid coffee extract having the second quality characteristic has different quality (e.g., lower quality) than the liquid coffee extract having the first quality characteristic. In some embodiments, the liquid coffee extract having the second quality characteristic may be used in products that have different (e.g., lower, less strict) quality standards, e.g., for coffee flavoring (e.g., for coffee-flavored ice cream products) or for other commodity products, including, for example, certain instant coffee. In some embodiments, the liquid coffee extracts having the first and second quality characteristics may be combined together in predetermined proportions to obtain a liquid coffee extract having a third quality characteristic.

In some embodiments, the brewing station tube 122 has multiple segments, e.g., four segments 122A, 122B, 122C, 122D, as shown in FIG. 1. In some embodiments, each of the multiple segments may be run in parallel. In some embodiments, each of the multiple segments may be run in series. In some embodiments, the coffee may be brewed in only some (and not all) of the segments of the tube. In some embodiments, some of the tube segments may be run in parallel and some of the tube segments may be run in series concurrently. In some embodiments, two or more tube segments are run in parallel. In some embodiments, the output of the liquid coffee extract obtained from a first group of one or more tube segments (e.g., 122A and/or 122B) may be combined with liquid coffee extract from a second group of one or more tube segments (e.g., 122C and/or 122D). In some embodiments, the liquid extract obtained using different tube segments or different groups of tube segments may be used for different products (e.g., different quality).

In some embodiments, the grounds may be re-run through one or more coils of the brewing station 103 to achieve desired quality, e.g., desired Brix. In some embodiments, re-running the grounds creates a pseudo-counter-current flow, allowing for extraction of additional product from the coffee.

In some embodiments, one or more coils may be taken off-line (e.g., for cleaning or maintenance), and the brewing station 103 may operate without the coil(s) that have been taken off-line. In some embodiments, one or more coils may be replaced with different coils depending on the desired characteristics of the final product (e.g., depending on desired Brix content). In some embodiments, the ability to take coils off-line or swap coils provides added flexibility to the overall system and allows one to achieve a final product (e.g., liquid coffee extract) with desired characteristics (e.g., quality).

In some embodiments, a sampling port may be included after each coil of the brewing station 103. In some embodiments, an operator samples a product after each coil to determine where the product should be directed to next (e.g., to another coil or to centrifuge/filter).

In some embodiments it may be determined through chemical or TDS analysis of the filtered slurry that some additional recovery of dissolvable solids would be possible from the grounds with a secondary brewing step. In some embodiments, the coffee grounds may be re-processed, e.g., passed through another tube segment or set of tube segments, after the filtration step. With reprocessing, fresh water can be used to extract additional solids from the beans. The water/extract from this second pass will generally yield a lower Brix as a final extract (as compared to the filtered slurry), since most of the dissolvable solids have already been removed from the grounds, but it can be used as the input solute to fresh beans introduced to the Brewer Station immediately after grinding. In some embodiments, this step will not yield a higher overall BRIX from the Brewer Station, but will recover more of the dissolvable solids in each of the beans and thus create a higher overall system yield.

For the ease of illustration, FIG. 1 shows a single outlet valve (each of valves 123A-D) and a single inlet valve (each of 124B-D) that control whether flow through each of the coiled sections of tube 122 occurs in parallel or in series or in a combination of parallel and series. It is within the scope of the invention to have more than one inlet and more than one outlet valve at the respective entrance and exit of each coiled section for controlling the flow of material through the brewing station 103. For example, in certain implementaions, additional valves and piping are included that enable one or more coiled sections of tube 122 to be bypassed. Moreover, one or more valves can be used in place of any of outlet valves 123A-D that enable material travelling in the common outlet tube section of tube 122 into a downstream inlet valve 124B-D. Such additional illustrative embodiments of brewing station 103 achieve a high level of flexibility in determining the path of material flowing through the overall system.

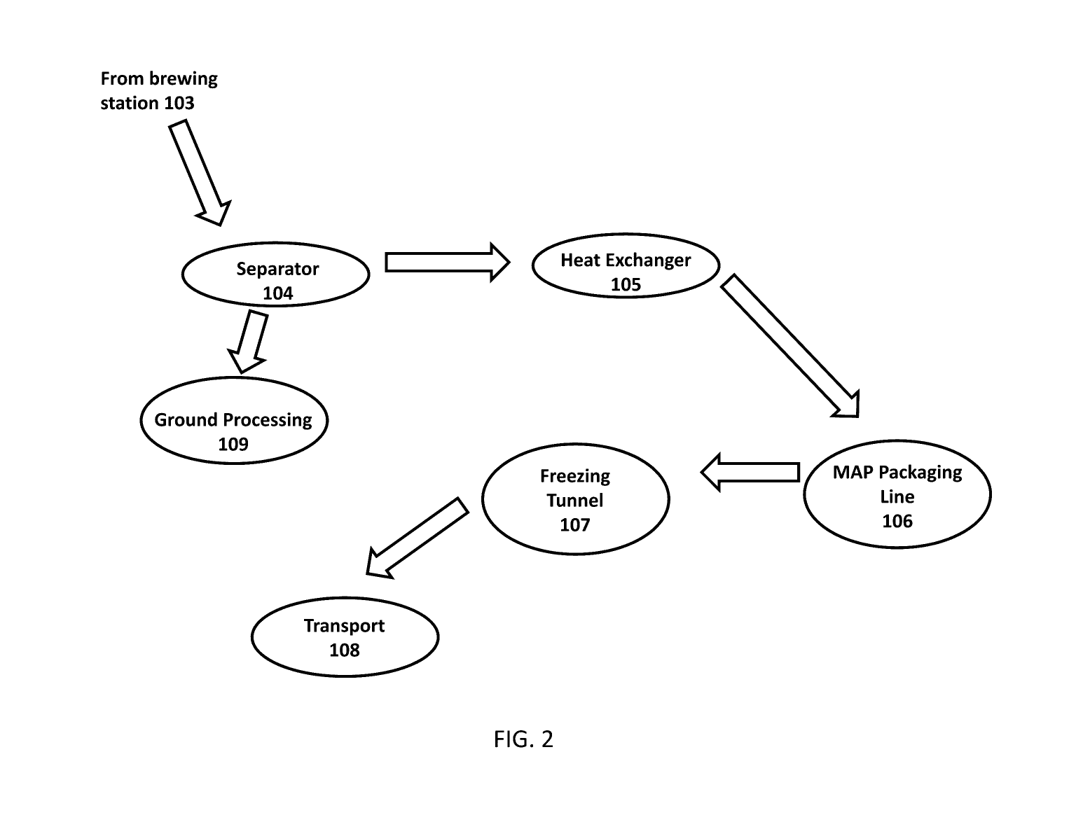

Referring to FIG. 2, once the slurry has been at a suitable temperature for the prescribed time, e.g., about 190-205° F. (about 88-96° C.) for about 5-15 minutes, e.g., once the brewing is complete, the grounds can be separated from the extract. In some embodiments, the slurry may be examined using, for example, chemical or TDS measurements in order to determine that the brewing process is complete. In some embodiments in this continuous process, a decanting centrifuge 104 shown in FIG. 2 can be used to continuously separate the grounds from the liquid extract. In some embodiments, the spent grounds are sent to a collection point for fuel or composting (109 in FIG. 2). In some embodiments, the spent grounds may be sent back to the brewing station 103 to obtain additional extractables.

This centrifuge device 104, which can be configured to continuously remove the grounds to waste, is very efficient at removing about 90-98% of the free extract (e.g., 90-91%, 90-92%, 90-93%, 90-95%, 95-98%) from the grounds, and can continuously deliver the extract to another pump (not shown) for onward movement to the heat exchanger 105. In some embodiments, the concentrated liquid extract passes through the heat exchanger 105 to reduce extract temperature to about 30° F. (about −1° C.). In some embodiments, the heat exchange process may occur prior to separation to minimize loss of volatile compounds during separation. The rotational speed of the centrifuge can be adjustable to allow removal of the large coffee grinds without removing the very small suspended solids that give the coffee some of its color, taste and texture. In some embodiments, the rotational speed will depend on the diameter of the centrifuge. For example, a centrifuge with a bowl size of 12″ diameter, the rotation speed may be 1-2000 rpm. In some embodiments, for larger diameter bowls, the speed will be proportionally slower. In some embodiments, the outlet of the centrifuge 104 can be an ideal place to measure the Brix, sample the taste of the extract, and make minor process modifications such as extraction time, brewing temperature, etc. to achieve the preferred Brix and taste. In some embodiments, the Brix can be adjusted over a small range by varying the temperature and/or the pressure of the slurry, and/or the initial particle size (e.g., since these may be easier to modify than the length of each particular segment 122A, 122B, 122C, 122D of the brewing station 103. For example, in some embodiments, by increasing the temperature a few degrees, such as, for example, from about 195° F. (about 91° C.) to about 200° F. (about 93° C.), more dissolvable solids may be extracted, but the taste will also change. In some embodiments the temperature may be increased by about 1, 2, 3, 4, 5, 1-5, or more than 5° C. The effects of pressure changes, especially pulsed pressure, are somewhat like squeezing a sponge. In some embodiments, pressure may be used to drive solvent into the bean and the pressure may be reduced to allow solvent to flow out. With greater extraction, however, as noted above, taste is also likely to change as additional components—possibly more bitter or acidic, are removed from the bean. In some embodiments, these parameters can be controlled by whether the water added at the pump 120 of the brewing station 103 is heated, to immediately start the brewing process, or introduced cold (e.g., ambient temperature) to delay the brewing process until the slurry heats up once it enters the portion of the tube 122 (or particular tube segments 122A, 122B, 122C, 122D) inside the water bath. In some embodiments, the length of the each segment (e.g., 122A) of the tube 122, or the length of the tube 122, can be changed for a major change in Brix (e.g., from about 20 Brix to about 30 Brix) and/or the extraction level. In some embodiments, the number of tube segments (e.g., coils) through which the slurry is passed can be increased or decreased to change Brix and/or the extraction level. As described herein, in some embodiments, with the appropriate sensors and automated valves, temperature controllers, motor speed controllers (for pumps), etc., there is great opportunity for introducing a high level of automation and control into this process for achieving consistent product quality. In some embodiments, the product quality may be precisely controlled using the systems and methods described herein.

In some embodiments, instead of, or in addition to the centrifuge 104, the coffee may pass through a filter. In some embodiments, the filtration step is completed prior to the slurry being introduced into the centrifuge 104. In some embodiments, the slurry is not introduced into the centrifuge and is only introduced into a filtration system instead. In some embodiments, the filtration step may involve spinning cone technology. In some embodiments, the filtration step, e.g., including filtration via spinning cone technology (e.g., using one or more spinning cone columns), may be used to both separate the liquid contents from the solid contents and to separate the volatile flavor and aroma compounds from the liquid to be captured, condensed, and recombined with the liquid extract once the dried grounds are completely removed. In some embodiments the aperture size of the filter can be adjusted to alter the solids that pass through the filter.

In some embodiments, the centrifuging and/or filtration step is carried out at elevated temperatures similar to the brewing temperatures used in the tube 122 (or individual tube segments 122A-D)—about 190° F. (about 88° C.) to about 205° F. (about 96° C.). In some embodiments, filtration takes place after the slurry has passed through a heat exchanger and has been reduced in temperature to about 30° F. (about −1° C.) to about 50° F. (about 10° C.) (e.g., as shown in FIG. 3B). In some embodiments, the centrifuging and/or filtration step is carried out in an enclosure that is flooded with nitrogen or another inert gas.

In some embodiments, the centrifuging and/or filtration step where the liquid passes through the filter to the capture collection area is chilled to 30° F. (about −1° C.) to 50° F. (about 10° C.).

In some embodiments, any suitable separation technique may be used to separate the liquid extract from the grounds. In some embodiments, reverse osmosis may be used for the separation. In some embodiments, a very fine (e.g., about 1-100 microns) filtration mechanism may be used to separate the liquid extract from the grounds. In some embodiments, a filter and a centrifuge are used to separate the liquid extract from the grounds in a 2-step process (e.g., the slurry goes through the filter and then through a centrifuge or vice versa) to achieve a desired level of separation, e.g., desired Brix.

In some embodiments, following the filtration and/or centrifugation, the extract is next pumped to heat exchanger 105 (e.g., in some embodiments this could be a tube-in-shell type or plate type exchanger) to reduce the extract temperature down to about 30-35° F. (about −1 to about 2° C.). In some embodiments, the cooling step can minimize the energy and time required for final freezing and it also ensures that any quality losses during the packaging process are minimized. In some embodiments this chilling step occurs before filtration, e.g., as shown in FIG. 3B.

At the end of the chilling process, in some embodiments, the coffee product can be sold as a pure coffee extract in bulk. In some embodiments, the coffee product can be packaged in bulk packaging, i.e., multi-serving portion packages or bags including, e.g., half gallon, gallon, 5 gallon, 50 gallon, 100 gallon, 500 gallon, 550 gallon bags (e.g., that may be further distributed or individually packaged in downstream operations).

In some embodiments, following the brewing and the chilling steps, the chilled extract can be packaged and frozen as shown in FIG. 2. For example, for individual consumers, a MAP (Modified Atmosphere Packaging) packaging line 106 can place the extract into single-serve packages (e.g., such as those disclosed in U.S. Pat. No. 9,346,611), preferably made from a recyclable material such as aluminum, so as to be fully recyclable while still providing good vapor barrier properties for the packaged extract. In some embodiments, a MAP packaging line 106 is where the liquid extract is transferred to single-serve or other immediate use sized packaging. In some embodiments, larger packaging for making carafes of coffee and formats which will better cater to coffee shops and restaurants such as multi-pack frozen pucks can be made. In some embodiments, to preserve freshness and a high quality taste in this process, the packaging and transfer to the flash freezing tunnel 107 can be configured to occur with minimal delay in queuing at the packaging machine once the product emerges from the heat exchanger 105. In some embodiments, the flash freezing tunnel 107 is used to solidify the coffee extract and virtually halt any future loss of quality or freshness. Once packaged and frozen, the product can be kept cold and delivered by refrigerated truck (e.g., 108 in FIG. 2) at the lowest practical temperature to consumers, or to the frozen food aisles of grocery stores or to refrigerated (e.g., frozen) storage at a restaurant or coffee shop.

In some embodiments, the techniques presented herein can provide for a fully continuous technique for making coffee extract, beginning with continuous roasting and continuing at a constant rate with the shortest possible delays at every step to a frozen single-serve or “immediate use” packaging format. In some embodiments, the techniques described herein can be configured for minimal wait times between steps. As described herein, in some embodiments, the choices of equipment other than the brewing station, 103, mentioned herein are illustrative, but intended to suggest at least one exemplary and non-limiting technique by which it should be possible to create a continuous process for making the best possible quality of the coffee extract. As discussed herein, the brewing station 103 is fully customizable based upon the desired characteristics of the coffee extract.

Referring now to FIG. 3A, an exemplary process 300A for producing coffee extract and transporting a packaged coffee extract product is shown. In some embodiments, any of the steps of the process 300A may be performed in a non-oxidizing environment (e.g., inert gas environment). In some embodiments, any of the steps of the process 300A may be performed in an oxygen-deprived or an oxygen-free environment (e.g., inert gas environment, e.g., nitrogen gas environment). The green coffee beans are roasted in step 302. In some embodiments, the roaster is a continuous roaster. In some embodiments, the roaster is a batch roaster (e.g., a fluidized bed roaster). The roasted coffee beans are ground to an appropriate coarseness level in step 304. In some embodiments, the roasted coffee beans are optionally transported to a storage chamber or equipment for chilling in step 303 prior to the grinding step. In some embodiments, storage or chilling of roasted coffee beans may be desired for certain roast types, e.g., dark roasts, to improve the quality of the final coffee extract. The roasted coffee beans may be transported from the storage chamber to the grinding device by any suitable equipment, including gravity and mechanical equipment such as a conveyor belt. Following grinding, the ground coffee beans are brewed in step 306. In some embodiments, prior to brewing, the ground coffee beans are sorted and separated in step 305. In some embodiments, the ground coffee bean granules may be sorted and separated by size.

In some embodiments, all of these grounds/granules can be used in the brewing station, but the parameters for water temperature, pressure and extraction duration will vary to yield the best tasting coffee. Processing of granules of as nearly a uniform size as possible is recognized as one of the key factors in consistently achieving high quality coffee and coffee extracts. For example, with smaller granules, the temperature and duration of brewing may both be reduced as compared to brewing operations with larger granules to achieve comparable taste and quality. In some embodiments, the ground beans of a predetermined size are transported to the brewing station 103 shown in FIG. 1 for brewing. Following the brewing step 306, the liquid coffee product is separated from the grounds in step 308 via filtration and/or centrifugation. In some embodiments, the coffee grounds may be recycled and used for other purposes (e.g., fuel). In some embodiments, following the filtering/centrifuging step 308, the coffee extract is cooled to a desired temperature in step 310. In some embodiments, the cooled coffee extract may be packaged in step 312. In some embodiments, the packaged coffee product may be frozen or flash frozen in step 314. In some embodiments, the frozen coffee product may be transported by a suitable carrier in 316.

In some embodiments, steps 302-310 may be carried out continuously (e.g., with minimal or no wait times between the different process steps, e.g., with the only time in between the steps being the time it takes to transport from one device to the next device). In some embodiments, the filtering/centrifuging step 308 may be repeated depending on the final product characteristics.

Referring now to FIG. 3B, a process similar to that shown in FIG. 3A may be used to continuously, or with minimal delay, create a frozen coffee extract of very high quality. The difference between the processes shown in the two figures is that in FIG. 3B, the cooling step 310 occurs prior to the filtration step 308.

In some embodiments, the use of the systems and methods discussed herein results in the coffee never encountering oxygen until, e.g., the frozen liquid coffee extract is dispensed in the cup from a specialized device. Illustrative examples of such devices are disclosed in U.S. Pat. No. 9,346,611, incorporated above, and U.S. patent application Ser. No. 15/099,156, filed on Apr. 14, 2016, titled “Method of and system for creating a consumable liquid food or beverage product from frozen liquid contents”, also incorporated by reference herein.

It is also contemplated as part of the techniques described herein that various components of the system include sensor technology that can automatically adjust the settings of, for example, the coffee roasting, grinding, brewing, filtering, or cooling to produce a final coffee product (e.g., frozen coffee product) having desired characteristics. This sensor technology may also be used to inhibit certain settings from being applied. For example, an electronic control system may inhibit an operator from applying certain settings. In some embodiments, this sensor technology assists in creating a desirable product and eliminating human error. In some embodiments, the electronic control system may inhibit an operator from applying settings that could over-roast or under-roast the coffee beans, for example.

Aspects of the techniques and systems related to continuously producing a coffee extract having desired qualities (e.g., desired Brix, desired extractable levels) and in a desired volume in an automated fashion as disclosed herein may be implemented as a computer program product for use with a computer system or computerized electronic device. Such implementations may include a series of computer instructions, or logic, fixed either on a tangible/non-transitory medium, such as a computer readable medium (e.g., a diskette, CD-ROM, ROM, flash memory or other memory or fixed disk) or transmittable to a computer system or a device, via a modem or other interface device, such as a communications adapter connected to a network over a medium.

The medium may be either a tangible medium (e.g., optical or analog communications lines) or a medium implemented with wireless techniques (e.g., Wi-Fi, cellular, microwave, infrared or other transmission techniques). The series of computer instructions embodies at least part of the functionality described herein with respect to the system. Those skilled in the art should appreciate that such computer instructions can be written in a number of programming languages for use with many computer architectures or operating systems.

Such instructions may be stored in any tangible memory device, such as semiconductor, magnetic, optical or other memory devices, and may be transmitted using any communications technology, such as optical, infrared, microwave, or other transmission technologies.

It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

Unless otherwise defined, used or characterized herein, terms that are used herein (including technical and scientific terms) are to be interpreted as having a meaning that is consistent with their accepted meaning in the context of the relevant art and are not to be interpreted in an idealized or overly formal sense unless expressly so defined herein. For example, if a particular composition is referenced, the composition may be substantially, though not perfectly pure, as practical and imperfect realities may apply; e.g., the potential presence of at least trace impurities (e.g., at less than 1 or 2%) can be understood as being within the scope of the description; likewise, if a particular shape is referenced, the shape is intended to include imperfect variations from ideal shapes, e.g., due to manufacturing tolerances. Percentages or concentrations expressed herein can represent either by weight or by volume.

Although the terms, first, second, third, etc., may be used herein to describe various elements, these elements are not to be limited by these terms. These terms are simply used to distinguish one element from another. Thus, a first element, discussed below, could be termed a second element without departing from the teachings of the exemplary embodiments. Spatially relative terms, such as “above,” “below,” “left,” “right,” “in front,” “behind,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations) and the spatially relative descriptors used herein interpreted accordingly. Further still, in this disclosure, when an element is referred to as being “on,” “connected to,” “coupled to,” “in contact with,” etc., another element, it may be directly on, connected to, coupled to, or in contact with the other element or intervening elements may be present unless otherwise specified

It will be appreciated that while a particular sequence of steps has been shown and described for purposes of explanation, the sequence may be varied in certain respects, or the steps may be combined, while still obtaining the desired configuration. Additionally, modifications to the disclosed embodiment and the invention as claimed are possible and within the scope of this disclosed invention.

Throughout the description, where articles, devices, and systems are described as having, including, or comprising specific components, or where processes and methods are described as having, including, or comprising specific steps, it is contemplated that, additionally, there are articles, devices, and systems of the present invention that consist essentially of, or consist of, the recited components, and that there are processes and methods according to the present invention that consist essentially of, or consist of, the recited processing steps.

The mention herein of any publication, for example, in the Background section, is not an admission that the publication serves as prior art with respect to any of the claims presented herein. The Background section is presented for purposes of clarity and is not meant as a description of prior art with respect to any claim.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Various modifications to the disclosed embodiments will be apparent to those skilled in the art, and the general principals set forth herein may be applied to other embodiments and applications. Thus, the present invention is not intended to be limited to the embodiments shown or described herein. The terminology used herein is for the purpose of describing particular embodiments and is not intended to be limiting of exemplary embodiments. As used herein, singular forms, such as “a” and “an,” are intended to include the plural forms as well, unless the context indicates otherwise.

For clarity, illustrative embodiments for different aspects of the system have been described with respect to the type and design of the receptacle, the nature of the frozen content, the means for melting and/or diluting the frozen content, and the delivery mechanism applied to the resulting melted liquid to create a consumable food or beverage on a just-in-time, consistent basis at the desired flavor, potency, volume, temperature, and texture. It will be apparent to one skilled in the art that these various options for receptacle type, form and characteristics of the frozen content, mechanisms for melting and/or diluting the frozen contents, and means for delivery of the liquefied contents can be combined in many different ways to create a pleasing final product with specific characteristics which can be conveniently enjoyed by the consumer.

1. A method for continuously producing a liquid coffee extract, comprising the steps of:
(1) roasting green coffee beans in a roaster to form roasted coffee beans;
(2) transporting the roasted coffee beans into a grinder;
(3) grinding the roasted coffee beans in the grinder to form ground roasted coffee beans;
(4) transporting the ground roasted coffee beans into a continuous brewing station;
(5) brewing the ground roasted coffee beans in the continuous brewing station to form a liquid coffee extract and a spent coffee grounds mixture, the brewing step comprising:
continuously receiving over a first time duration a predetermined quantity of the ground roasted coffee beans at an inlet port of the continuous brewing station;
continuously receiving over the first time duration a predetermined quantity of water at the inlet port of the continuous brewing station; and
continuously co-flowing over the first time duration the predetermined quantity of ground roasted coffee beans and the predetermined quantity of water through a tube, the tube having dimensions selected to provide a predetermined brewing time;
(6) transporting the liquid coffee extract and spent coffee grounds mixture to a continuous separation system through an outlet port of the continuous brewing station; and
(7) separating, using the continuous separation system, the liquid coffee extract from the spent coffee grounds.

2. The method of claim 1, comprising roasting the green coffee beans in a continuous roaster.

3. The method of claim 1, comprising grinding the roasted coffee beans in a continuous grinder.

4. The method of claim 1, comprising cooling the liquid coffee extract to a cooled extract temperature prior to step (7) or after step (7).

5. The method of claim 4, comprising packaging the cooled liquid coffee extract into single-serve packaging or bulk packaging.

6. The method of claim 1, comprising packaging the liquid coffee extract and flash freezing packaged liquid extract to preserve freshness.

7. The method of claim 1, wherein the separating step comprises filtering the liquid coffee extract from the spent coffee grounds to achieve a predetermined Brix value for the liquid coffee extract.

8. The method of claim 1, wherein the separating step comprises separating the liquid coffee extract from the spent coffee grounds in a spinning cone column.

9. The method of claim 1, wherein the separating step comprises centrifuging the liquid coffee extract and the spent coffee grounds mixture.

10. The method of claim 1, wherein the separating step is a two-step process comprising filtering and centrifuging the liquid coffee extract and the spent coffee grounds mixture in a non-oxidizing environment.

11. The method of claim 1, wherein the separating step is a two-step process comprising filtering and centrifuging the liquid coffee extract and the spent coffee grounds mixture where the collection from the centrifuge is chilled to 30° F. to 50° F.

12. The method of claim 1, comprising measuring a Brix value of the liquid coffee extract following the separation step.

13. The method of claim 1, wherein the roasted coffee beans are transported from the roaster to a storage container for a predetermined storage period prior to step (2) or to a bean chilling system.

14. The method of claim 1, comprising sorting the ground roasted coffee beans after grinding to achieve uniform coffee grind size prior to step (4).

15. The method of claim 1, comprising adjusting at least one of the predetermined quantity and temperature of the water to control a Brix value of the liquid coffee extract.

16. The method of claim 1, wherein the tube is selected from the group consisting of a coil, a straight tube, serpentine tube, a shell-and-tube.

17. The method of claim 16, wherein the tube is dimpled to impart turbulence.

18. The method of claim 16, wherein the tube is selected to control an amount of agitation to prevent addition of undesirable solids to the liquid coffee extract.

19. The method of claim 1, wherein the dimensions of the tube are selected to provide the predetermined brewing time and to provide predetermined pressure and temperature conditions within the tube.

20. The method of claim 1, wherein the tube comprises multiple segments, the method comprising selecting which one or more of the multiple segments of the tube receives at least a portion of the predetermined quantity of ground roasted coffee beans and at least a portion of the predetermined quantity of water and which one or more of the multiple segments of the tube does not receive ground roasted coffee beans and water to provide for the liquid coffee extract having predetermined characteristics.

21. The method of claim 1, wherein the tube comprises multiple segments, the method comprising replacing or modifying one or more segments of the tube to modify a rate of extraction of compounds from the ground roasted coffee beans.

22. The method of claim 1, wherein the tube comprises multiple segments, at least one of the multiple segments comprising at least one pressure transducer, the method comprising measuring an internal tube pressure and adjusting the internal tube pressure to obtain the liquid coffee extract having predetermined quality characteristics.

23. The method of claim 22, wherein the pressure is pulsed to enhance extraction of dissolvable solids.

24. The method of claim 1, wherein the tube comprises multiple segments, the method comprising independently controlling operating conditions for each of the multiple segments.

25. The method of claim 1, wherein the tube comprises multiple segments, wherein at least some of the multiple segments are arranged in series, wherein the brewing step comprises flowing the ground roasted coffee beans and the water through more than one segment in the series to achieve an additional level of liquid coffee extraction relative to flow through a single tube segment.

26. The method of claim 1, wherein the tube comprises multiple segments, wherein at least some of the multiple segments are arranged in parallel, wherein the brewing step comprises flowing the ground roasted coffee beans and the water through more than one segment of the tube in parallel to increase output relative to flow through a single tube segment.

27. The method of claim 1, wherein the tube comprises multiple segments, the multiple segments comprising a first group of tube segments and a second group of tube segments, wherein the ground roasted coffee beans flow through the first group of tube segments in step (5), and the method further comprising, after step (7), transporting the separated spent coffee grounds to the second group of tube segments, distinct from the first group of tube segments, for further extraction.

28. The method of claim 1, wherein the inlet pump is a twin-screw pump or a positive displacement pump.

29. The method of claim 1, wherein at least one or more of the steps (1)-(7) is completed in a non-oxidizing environment.

30. A system for continuously producing a liquid coffee extract, comprising:
(1) a roaster for roasting green coffee beans to form roasted coffee beans;
(2) a grinder for grinding the roasted coffee beans to form ground roasted coffee beans;
(3) a continuous brewing station for forming a liquid coffee extract and a spent coffee grounds mixture, the continuous brewing station comprising:
an inlet port for continuously receiving over a first duration a predetermined quantity of the ground roasted coffee beans and a predetermined quantity of water;
a tube in fluid communication with the inlet port comprising multiple segments, wherein at least one segment has dimensions selected to provide a predetermined brewing time; and
an inlet pump for co-flowing the predetermined quantity of ground roasted coffee beans and the predetermined quantity of water into the tube; and
(4) a continuous separation system for separating the liquid coffee extract from the spent coffee grounds.
